(19) United States
(12) Patent Application Publication
(10) Pub. No.: US 2007/0295218 A1
(43) Pub. Date: Dec. 27, 2007

(54) Multi-use durable coffee pot system

(76) Inventor: Sung Suk Kim, Umatilla, OR (US)

Correspondence Address: Yoon Suk Kim, 4424 S. E. 135th, Portland, OR, 97236, US

(21) Appl. No.: 11/479,857

(22) Filed: Jun. 27, 2006

Related U.S. Application Data
(63) Continuation of application No. 11/237,416, filed on Sep. 27, 2005, now abandoned.

(51) Int. Cl. A47J 31/44

(52) U.S. Cl. 99/284

(57) ABSTRACT

A highly heat resistant durable coffee pot system for use in preparing beverages and in cooking. The system consists of a cylindrical hollow pot body (6) with pot handle (5), and spout (9) manufactured of carborundum material. A separate lid (4) is provided, incorporating a lid handle (3) for grasping the lid which fits snugly over the pot body opening. Safety hanger eyes (10) employed within the pot body, a stainless steel safety hanger (2) attaching to said eyes, and a hook (1) is provided to allow the pot to be suspended by its hanger. Also employed is a threaded screw-top filter bottle (8) with corresponding threaded filter cap (7). The filter bottle contains numerous small perforations. The bottle floats freely in the pot when agitated by boiling water. The system is not subject to cracking or warpage and can be used with nearly any heat source being constructed of extremely durable carborundum material.

### BACKGROUND OF INVENTION

1. Field of Invention

This invention relates to a divice used for the preparation of beverages such as coffe, food-including deep frying, and herbal medicines. Which is a highly durable container constructed of high carborundum matrial and is suitable for use is or over any heat source and includes a free-flouting filter bottle assembly which extracts ingredients from the bottle when submerged in boiling water.

2. Description of Prior Art

Several styles of container for preparatoin of beverage or of food items have been presented in prior art. By one means or another, these pot systems are said to be for the preparation of coffe, tea, or other beverages, herbal medicines, and food items. While these pots may operate in their prescribed manner they display shortcomings in desing or apatability for their intended use.

1. Perculator systems consist of a pot in which boiling water is circulated through a small chamber holding ground coffee beans. The chamber generally requires a paper filter which allows the liquid to pass through the chamber while preventing passage of grounds into the pot body.

Generally, due to their design, which entails a built-in apparatus for holding the filter chamber, percolator system are suitable for the preparation of coffee, but not for other beverages or food items and cannot be used for deep frying. My invention requires no paper filter due to the sealed bottled system acting to prevent coffee grounds from escaping into the water. The filter bottle allows content extraction as it circulates continuosly within the agitated action of boiling water.

2. Percolator system may be equipped with a built-in electric heating element and thus are only usable in locations where electricity is available. Non-electric percolator pots are constructed of low-durability materials, and thus their use is restricted to low-heat sources.

3. Other pot system used for cooking or preparation of beverages are of lower durability than this proposed design and cannot with-stand subjection to almost any high heat source including eletric heating element, microwave oven, barbeque charcoal, propane gas, natural gas, wood, or paper burning in open flame. Wheras the present invention is specifically designed of such material as to allow use in high-heat conditions without warpage, shattering, or cracking.

### SUMMARY OF THE INVENTION

1. The primary object of this invention is to provide a container for use in heating liquids for cooking over the Following heating sources;

Electric heating element, microwave oven, barbecue, charcoal, propane gas, natural gas, wood or paper burning in open flames

This system is extremely durable, allowing deep frying if desired, due largely to its construction of carborundum material which avoids craking or shattering if dropped, thereby increasing public safety. This affords a significant improvement over traditional pots which are made of glass or metals.

The pure carborundum construction is sufficiently durable in that the product will remain intact for generations of life time use!

2. The secondary object of this invention is to employ a filtering device which uniformity allows its contents into the aggited boiling water without paper filters. This sealed filter bottle is designed to be boiled in the water providing a more efficient usage of its contents and the effectiveness continues even if the pot is removed from the heating source. Thus, more complete usage of coffee grounds, or other desired content, is achieved over any perculator system. Removal of the filter bottle and usage of cooking oil allows deep frying. The carborundum material used in the Multi-use Durable Coffee Pot System consists of the pot body and handle. the lid and filter bottle and cap. The safety hanger and hook is made of stainless steel only. Due to the Multiple heating sources and the wide variation of food types or beverages, This system proves for more usable than any other system. The durability of this pot would be hard to match let alone the convience of use and cost effectiveness. The carborundum material is far superior than any other system.

There is no support structure for the filter bottle within the pot body as customary in perculator system.

The filter bottle floats freely in the liquid of the pot with the exception of deep frying.

This results in a saving of material used in the manufacture and increases the simplicity of use. No paper filter is required or replacement filters as all coffee, tea or herbal medicines are sealed in the filter bottle.

Holes in the filter bottle are sufficiently small enough to allow the liquid leakage of the ingredients with preventing the release of fiorous contents.

Further objects and advantages of the Multi-use Durable Coffee Pot System will become apparent as the description proceeds.

To the accomplishment of the above and related, this invention may be modified in the form illustrated in the accompanying will attention being called to the fact that the drawings are illustrative only and that changes may be made in the specific construcation illustrated and described within the scope of the appended claims.

In accordance with the presented art and appended claims, the present invention is a multiple use highly durable coffee pot system for use in preparing beverages and foods over heat sources.

### BRIEF DESCRIPTION/SEVERAL VIEWS OF THE DRAWINGS

The embodiment of the invention is illustrated in it's design and construction and will be more fully understood from the following description, when read in conjunction with accompanying drawings where;

FIG. 1 is a side-view showing the Multi-use Durable Coffee Pot System pot hanger, pot lid, and filter bottle with lid.

FIG. 2 is a perspective side-view of this version of the Multi-use Durable Coffee Pot System shown at an angle depicting said system with lid removed and filter bottle placed inside pot with said bottle's lid removed.

FIG. 3 is a side-view of the Multi-use Durable Coffee Pot System shown with pot lid sealed onto pot body, and the filter bottle with said bottle's lid sealed onto filter bottle.

### REFERENCE NUMERALS IN DRAWINGS

1. Hook (Stainless Steel) 6. Pot Body
2. Safety Hanger (Stainless Steel) 7. Filter Cap
3. Lid Handle 8. Filter Bottle
4. Lid 9. Spout
5. Pot Handle 10. Safety Hanger Eye

### DETAILED DESCRIPTION OF THE INVENTION:

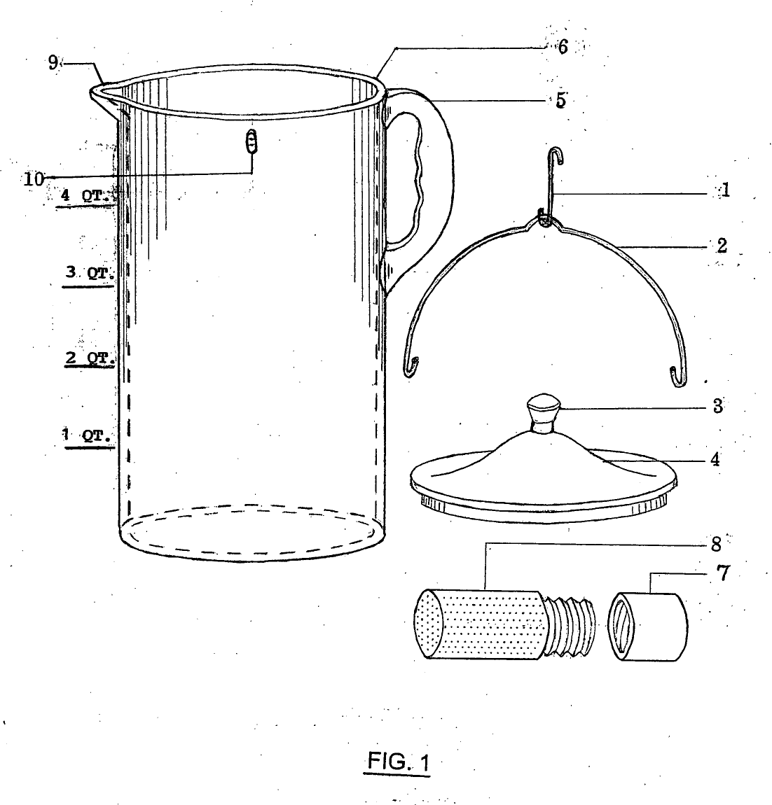

The Multi-use Durable Coffee Pot System is depicted in FIGS. 1, 2, and 3.

Referring to FIG, 1, a side-view of the pot system and accessories. The stainless steel hook 1 allows the pot to be suspended from a device such as a cooking tripod over and open flame.

The hook 1 attaches to the stainless steel hanger 2 wich attaches to two points on the side of the pot body and allows the user to grasp onto to steady the heavily loaded pot for safety reasons.

The lid handle 3 is manufactured of carborundum material and allows the user to grasp the carborundum pot lid 4, having a lip which allows the lid to secure firmly over the pot body 6.

The filter bottle 8, a cylindrical body is also made of carborundum and contains multiple perforations over its entire surface area, allowing water to pass through the opening while preventing coffee grounds from exiting the perforations.

The filter cap 7, which locks in the contents of the filter bottle 8, contains threads for screwing onto filter bottle 8 which contains corresponding threads.

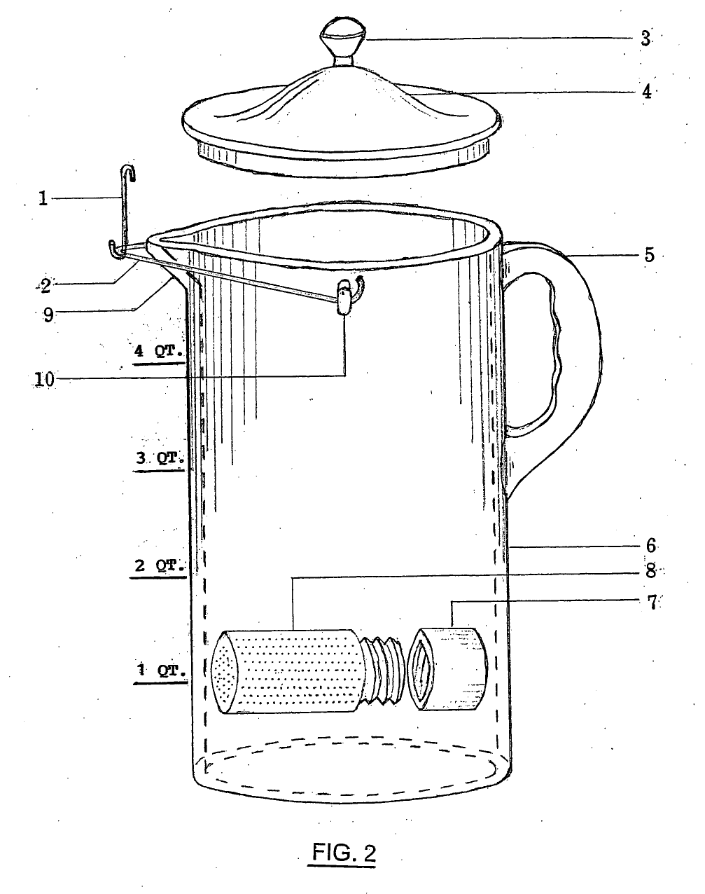

Referring now to FIG. 2, A perspective side view of the Multi-use Durable Coffee Pot System. The stainless steel safety hanger 2 is attached to the carborundum pot body 6, using the safety hanger eyes 10 which are molded into the pot body 6.

The safety hanger 2, is used for grasping the pot along with the carborundum pot handle 5, which is molded into the pot body 6. The spout 9 is used for pouring liquid from the pot body 6, and is molded into the pot body 6. Inside the pot body 6, is the filter bottle 8 with the filter cap 7 removed, suspended as if in liquid. The lid 4 with lid handle 3 is shown in the removed position from the pot body 6.

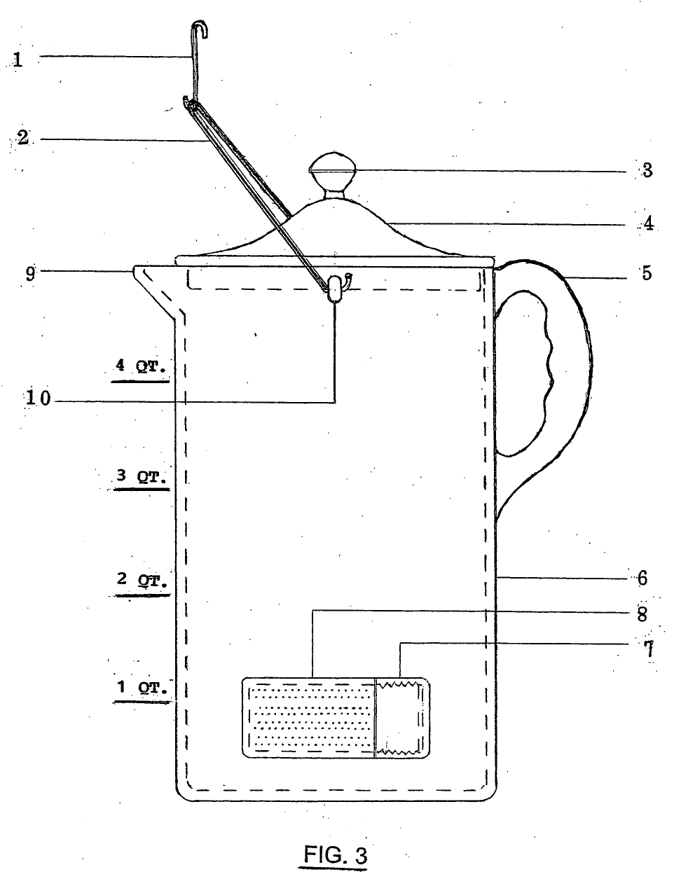

FIG. 3 is a side view of the Multi-use Durable Coffee Pot System. The lid 4 is shown secured onto the pot body 6. The bottom circumference of the lid 4 fits inside the pot body 6 walls, the lid 4 being of slightly lesser diameter than the pot body 6, The angled lid top at 4 is of slightly greater diameter than the pot body 6 and overlaps the pot wall edges to prevent any liquid, condensation, or contaminants from entering the pot. The filter cap 7 is shown securely locked onto the filter bottle 8 by means of screw threads. The filter components are demonstrated in the appropriate position for the preparation of coffee or other beverage requiring extraction from the filter bottle 8.

The operation of the present claimed invention will now be discussed.

To prepare a beverage using the Multi-use Durable Coffee Pot System, the following steps should be followed:
1. Fill filter bottle 8 with desired amount of ingredient (e.g. coffee grounds or tea).
2. Lock filter cap 7 by turning after attaching it to filter bottle 8.
3. Add desired amount of water to pot body 6.
4. Secure lid 4 by pushing it into pot body 6.
5. Heat and serve beverage, pouring by holding the pot handle 5, and optionally also by the safety hanger 2, tipping the container until beverage flows from the spout 9.

I claim;

1. A coffee pot system for use in preparing coffee, other beverages, and foods with a system comprising;
a) A highly heat resistant molded carborundum pot body with molded lid, molded handle and spout in the pot body, wich holds liquid for preparation of beverages or for use in food preparation including deep frying with oil and or boiling water.
b) A separate highly heat resistant carborundum reusable filter bottle with capused for containing coffee grounds, tea, or herbal medicines which is sealed and submerged into boiling water in the pot body.
The agitation of the boiling water causes the usuable contents of the filter bottle to be extracted into the water efficiently, and more completely than percolator systems;
c) A stainless steel safety hanger and hook used for assistence in handling the pot system, the safety hanger being attached to the pot body, and the detachable hook used to attach to the hanger for suspending the pot over a heat source.

2. The coffee pot system as claimed in claim 1, wherein said filter bottle contains multiple small perforations allowing water to move through the filter bottle, extracting contents, while preventing ground coffee beans or other fiberous material from exiting the bottle and where the filter bottle requires no paper filter, as opposed to percolator systems.

3. This coffee pot system as claimed in claim 1, wherein the pot lid, filter bottle, and filter bottle cap are constructed of highly durable and heat resistant carborundum.
The material allows usage at extremely high temperatures, and over multiple heating sources incluiding electric heating element t, microwave oven, charcoal, coal, natural gas, propane, or wood.
This system can be used before, during and after natural disasters, providing greater versatility over percolator systems.
The level of liquid in the pot can easily been seen through the semi transparent properties of the material.
